(19) United States
(12) Patent Application Publication
(10) Pub. No.: US 2003/0074351 A1
(43) Pub. Date: Apr. 17, 2003

(54) System and method for generating a work set of patents or other documents

(76) Inventors: Eric D.F.D. van Stegeren, San Jose, CA (US); Thomas D. Griffin, Campbell, CA (US); Mark Jackson, Fremont, CA (US); Edward Salatovka, San Jose, CA (US); Jeffrey D. Mansfield, Glen Ellyn, IL (US); Cindy Poulos, Carol Stream, IL (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/262,504

(22) Filed: Oct. 1, 2002

Related U.S. Application Data
(60) Provisional application No. 60/326,185, filed on Oct. 1, 2001.

(51) Int. Cl. G06F 7/00

(52) U.S. Cl. 707/3

(57) ABSTRACT

A system and method for generating a work set of documents is disclosed. In a preferred embodiment, the documents being grouped together are patent documents. The system and method create work file records that name the work file and contain document identifiers for a list of documents that the user wants to group together. The document identifiers contained in the work file records link to document records stored on a document database. By grouping documents together, a system user can recall the group of documents for review or some form of analysis at a later time.

CROSS-REFERENCE TO RELATED APPLICATIONS

This application claims priority from U.S. Provisional Application No. 60/326,185 entitled “System and Method for Generating a Work Set of Patents or Other Documents”, filed Oct. 1, 2001, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Systems and methods exist for searching for patents in computer databases and then applying various functions in the system to the patent search results. These systems are capable of searching patent documents based on user specified criteria, displaying a list of patent documents based on the user criteria, and then allowing the user to apply other features of the system to the retrieved patent documents. These systems provide multiple methods for entering the criteria used for searching for patent documents, such as: keyword searches based on the content of the patent document; searching by patent number; or creating Boolean searches based on a combination of fields. Users of these systems create queries to be used when searching for patents. These systems apply the user's criteria to search the patent documents in the computer database and create a list of patent documents that match the query entered by the users. Some of these systems may also provide relevancy ratings for the patents retrieved, using a scoring method or some other method to indicate to the user the relevancy of the retrieved patents. Once a list of patents is retrieved, the user may review the list of results to determine the search's efficacy. If the user decides the search results are useful, the user may decide to then apply other available functions to the list. If the user determines the results are not useful, the user may modify the search criteria and re-execute the search.

Often when working with the results of these searches, users need to be able to re-create the results set for processing at a later time. They may want to analyze the results based on a different set of criteria, or they may want to slightly modify the results, adding in other patents that they have identified as relevant to their inquiry. Users may also want to combine the results of multiple searches for the analysis they are performing. They may wish to perform this analysis based on the combination of the entire results of multiple searches or based on only those patents that are common between multiple searches. Users may also need to have these searches repeated based on a set time frame in order to determine any changes during that time.

However, systems and methods that are presently available are limited in that they do not provide a mechanism to save the result set of a search. Instead, to use these systems, users must record the search query, re-enter it and re-search the collection. Users also are not able to delete specific patent data from their search results. Instead they must identify specific search criteria that would eliminate the unwanted patent data, add this to their search criteria, and then re-execute their search. To perform analysis of the results of multiple searches, they must combine their search criteria and re-execute their search. The creation of search queries that allow for the analysis of patent data that is common between multiple searches usually requires the creation of complex Boolean search algorithms. With all of these searches, the results of the search can be different based on addition of new patents to the patent data being searched.

Accordingly, there is a need for a system capable of providing a method for the user to generate a work set of patents. This work set of patents would allow the users to generate and maintain lists of patents documents, and then apply other features of the system to this list of patents. This application could occur immediately after the list is created or at a later point in time. The user could apply this list of patents to other features of the system multiple times.

### SUMMARY

The present invention relates to a system and method for validating, generating, storing, retrieving, modifying, displaying, and applying a work set of patents or other documents. Suitable uses for work sets may include patent inventory systems, but may also be applied to any system that needs to provide system and user interfaces to large amounts of data.

The work sets may reside within a secured computer complex and may be accessed by the user via the “Internet”. The “Internet” may consist of any network connection including the public Internet, dedicated connection, or Virtual Private Network. The computer complex may exist behind one or more firewalls to prevent unauthorized access to the work sets.

Embodiments of the system of the invention allow users to create work sets using various methods. Users may save an entire set of patent documents resulting from a search of patent documents, or selected patent documents from a search result set as a work set. Users may also manually enter multiple patent numbers to create a work set. They may also import an existing computer file of patent numbers to create a work list. When entering a list of patent numbers or importing a file of patents, the system may provide a method for the user to correct any invalid patent numbers or create the work set with just the patent numbers that are desired. Users may create multiple work sets and provide a name and description for each set.

Embodiments of the system of the invention also allow the user to create a work set based on the combination of existing work sets. When combining work sets to create a new work set, the user may specify if all patent numbers from the files being combined should be incorporated into the new work set or if only patent numbers that are present in all the files being combined should be incorporated into the new work set.

Embodiments of the system of the invention provide a method for the users to access and maintain work sets that they have created. Such systems allow the user to display a list of the work sets he or she has created along with each work set's description. By using the name of existing work sets, users may access existing work sets. Such systems allow for the addition and deletion of patent numbers from the sets. Such systems allow for the addition of patent numbers to the set using the same methods as the original creation of the set: from a complete search result set; from selected patents in a search result set; by entering a single or multiple patent number; or by importing an existing file of patent numbers from the user's computer. When modifying an existing work set, such systems allow the user to save the updated work set with the same name and description, or with a new name and description. Such systems also allow the user to delete a work set in its entirety.

Embodiments of the system of the present invention may also allow users to apply other functionality available on the system to generated work sets. Such systems may also allow users to apply multiple functional components to a generated work set. Depending on the functional component being applied, a system user may also have the capability to apply the functional component to an entire work set or to just a portion of the work set.

### BRIEF DESCRIPTION OF THE DRAWINGS

These and other features, aspects, and advantages of the present invention will become better understood with regard to the following description, appended claims, and accompanying drawings where:

FIG. 1 illustrates an exemplary architecture of an embodiment of a system of the present invention;

FIG. 2 illustrates an exemplary architecture of an embodiment of a system of the present invention;

FIG. 3 depicts an exemplary patent document database having a patent record;

FIG. 4 depicts an exemplary patent collection with index entries;

FIG. 5 is a flowchart of exemplary steps performed in generating a work file;

FIG. 6 depicts an exemplary work file meta table on a patent database;

FIG. 7 depicts an exemplary work file item record on a patent database;

FIG. 8 is an exemplary patent search user interface;

FIG. 9 is an exemplary user interface displaying the results of a patent search;

FIG. 10 is an exemplary work file creation user interface;

FIG. 11 depicts an exemplary work file record on a work file database;

FIG. 12 is an exemplary work file administration user interface;

FIG. 13 is an exemplary work file viewer user interface;

FIG. 14 is an exemplary merge work file user interface; and

FIG. 15 is a portion of an exemplary work file administration user interface.

### DETAILED DESCRIPTION OF THE INVENTION

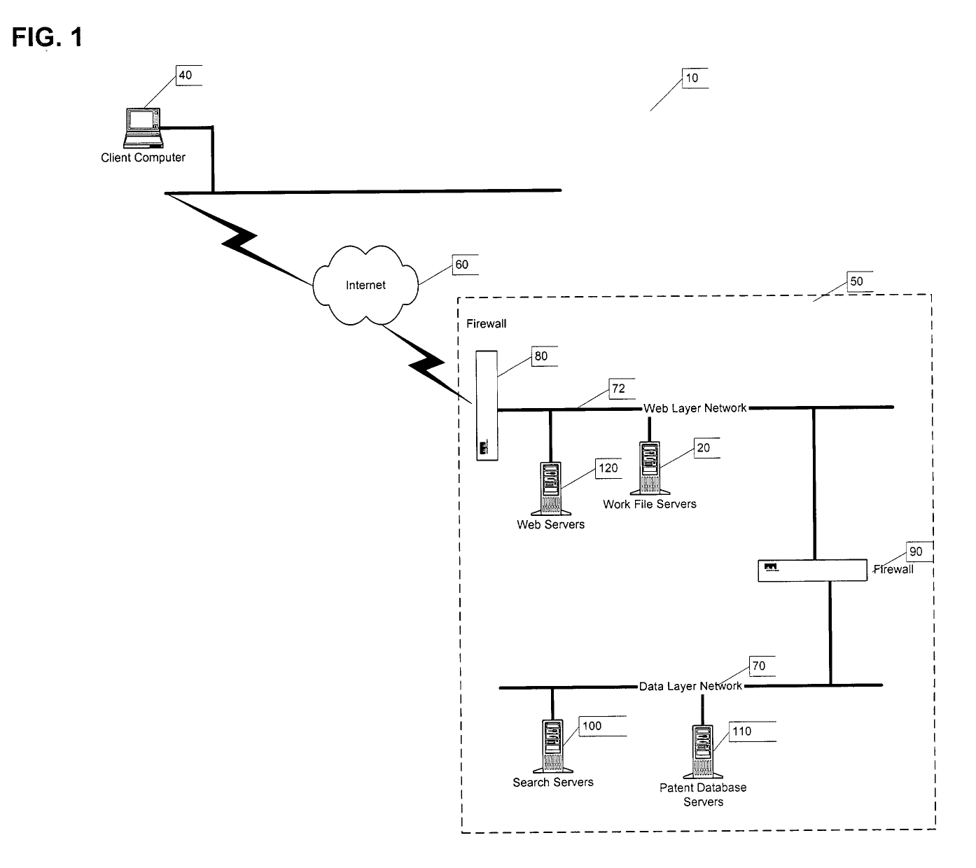

FIG. 1 depicts an embodiment of the system and method of the present invention 10. In this embodiment, the system 10 includes a computer complex 50 and at least one client computer 40 in communication with the computer complex 50 in a networked computer environment. It should be noted that only one client computer is depicted to simplify the explanation, but it should be understood that the system and method of the present invention may handle any number of client computers and may also handle any type of client computer. In this embodiment, the client computer 40 communicates with the computer complex 50 via the Internet, and 60 the computer complex 50 consists of a number of servers attached to two networks, namely the web layer network 72 and the data layer network 70. Also in this embodiment, the networks 70, 72 are separated from the Internet 60 and each other by firewalls 80, 90. Attached to the data layer network 70 are search servers 100 and patent database servers 110. The search servers 100 perform two major functions; indexing data, and making it available in response to a user's query. The patent database server 110 houses the source patent data and also serves as a storage area used to generate, validate, and view work sets. Attached to the web layer network 72 are web servers 120 and Work File Servers 20. The web servers 120 handle traffic between the computer complex 50 and the client computer 40. The Work File Servers 20 maintain the master copy of the work sets.

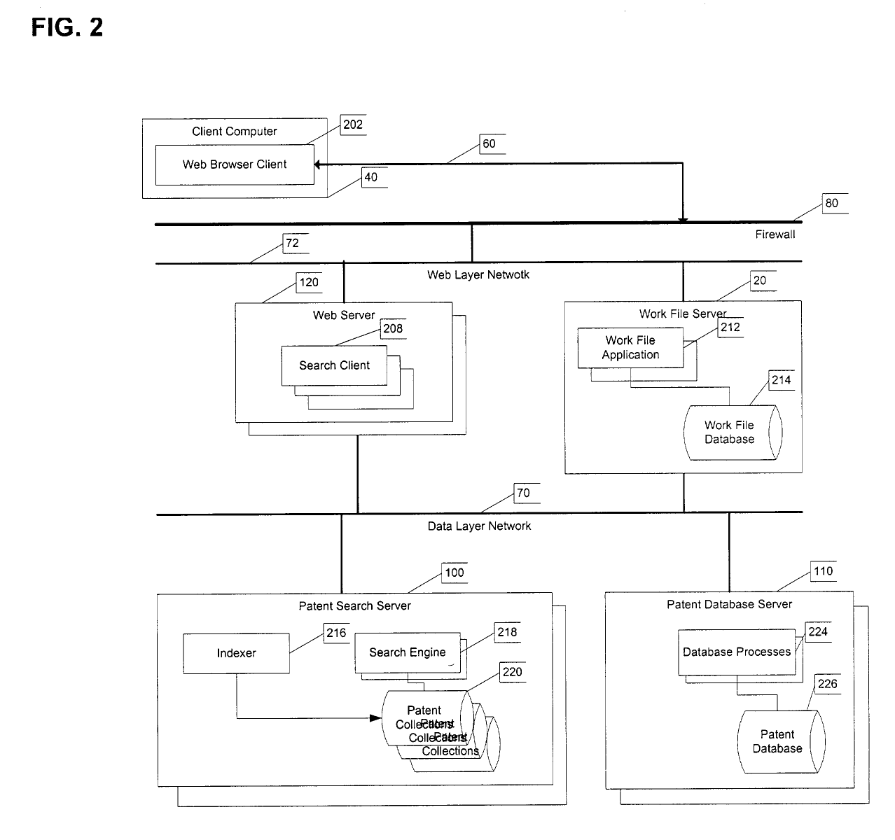

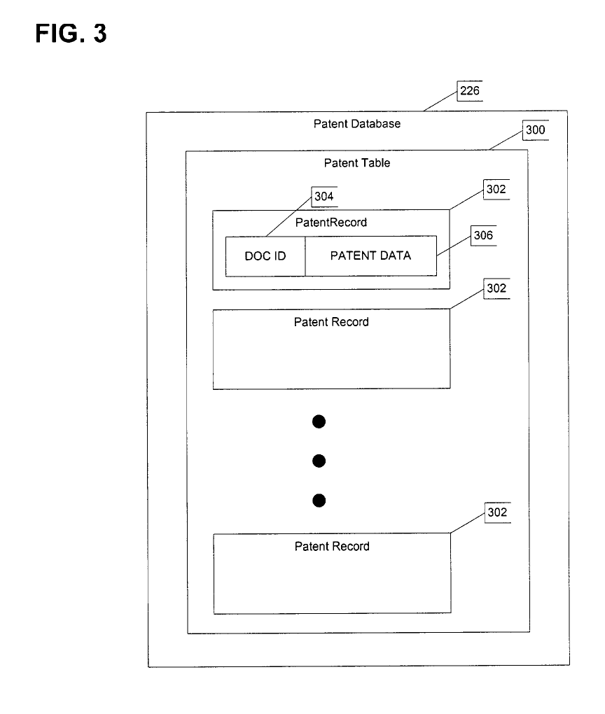

Referring to FIG. 2, stored system processes and a system data structure of one embodiment of the present invention are illustrated. In this embodiment, the web server 120 contains search clients 208. The work file server 20 contains work file application 212 and a work file database 214. The patent database servers 110 contain database processes 224 and patent databases 226. The patent database 226 includes a patent database table 300 (FIG. 3). Referring to FIG. 3, each patent database table 300 includes patent records 302 (typically 10's of millions of records) that each contain a document id 304 and patent data 306. The patent data 306 is composed of bibliographic and/or full text records, which may be obtained from the primary patent issuing authority or some comparable resource. As those skilled in the art of database design will recognize, the patent database 226 may contain many database tables that share a common key (document id 304).

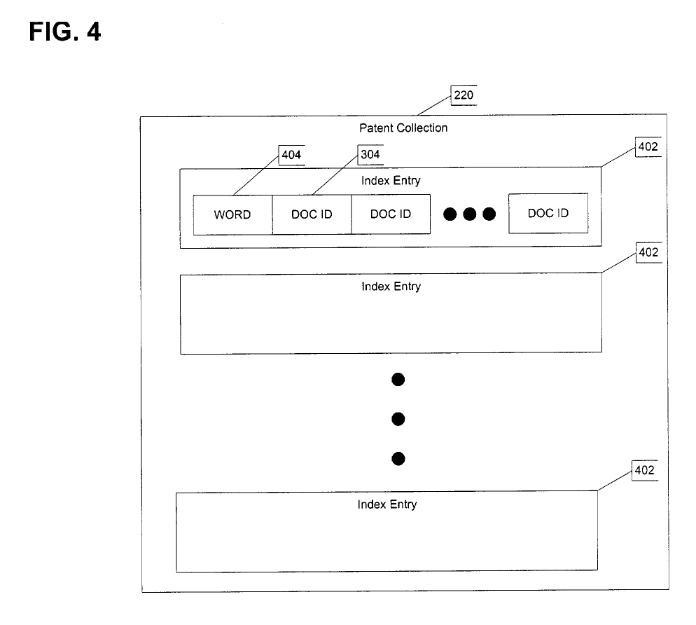

The patent search servers 100 include a patent indexer 216 and a patent search engine 218. The patent indexer 216 typically retrieves all patent records 302 from patent database 226 and stores them in the patent collections 220. Referring to FIG. 4, each patent collection 220 has a number of indexed entries 402 that are later used by search engine 218. Each index entry 402 is comprised of a word field 404 (a word from the original patent document) and an array (or similar structure) of document ids 304.

System Operation

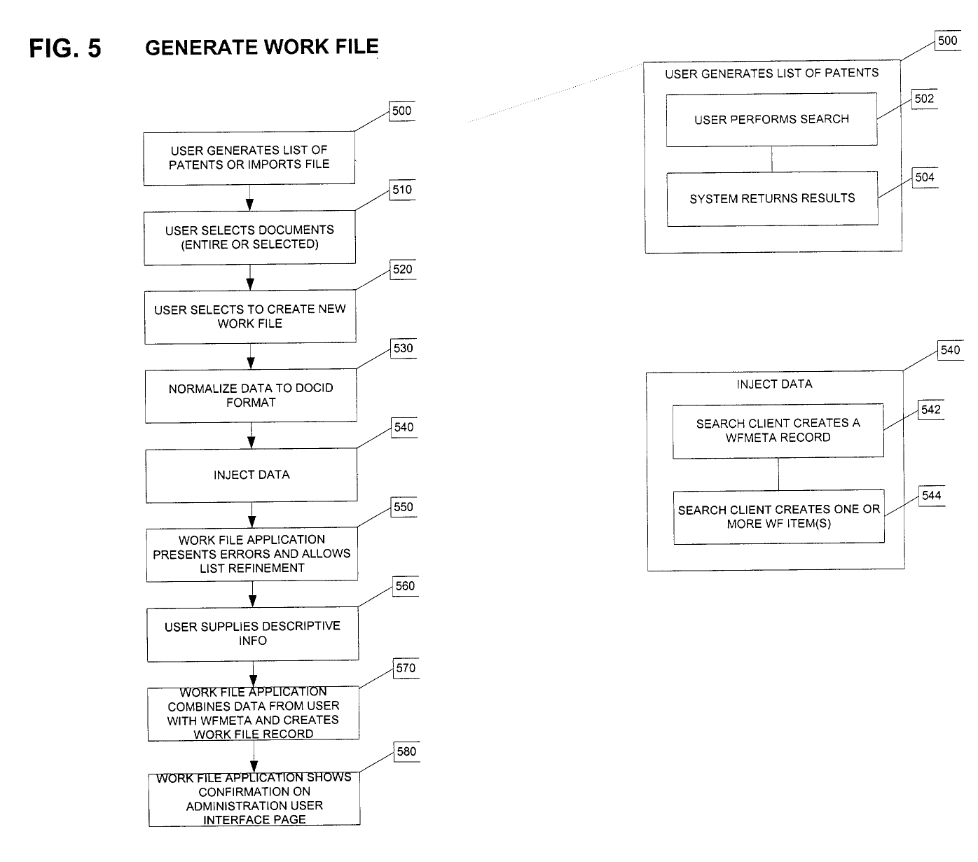

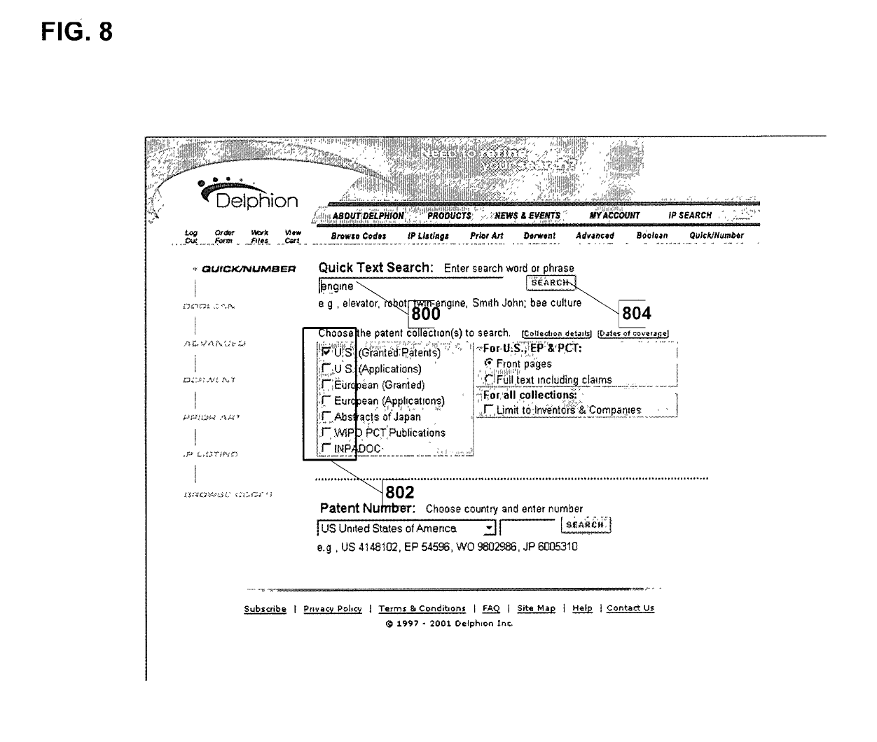

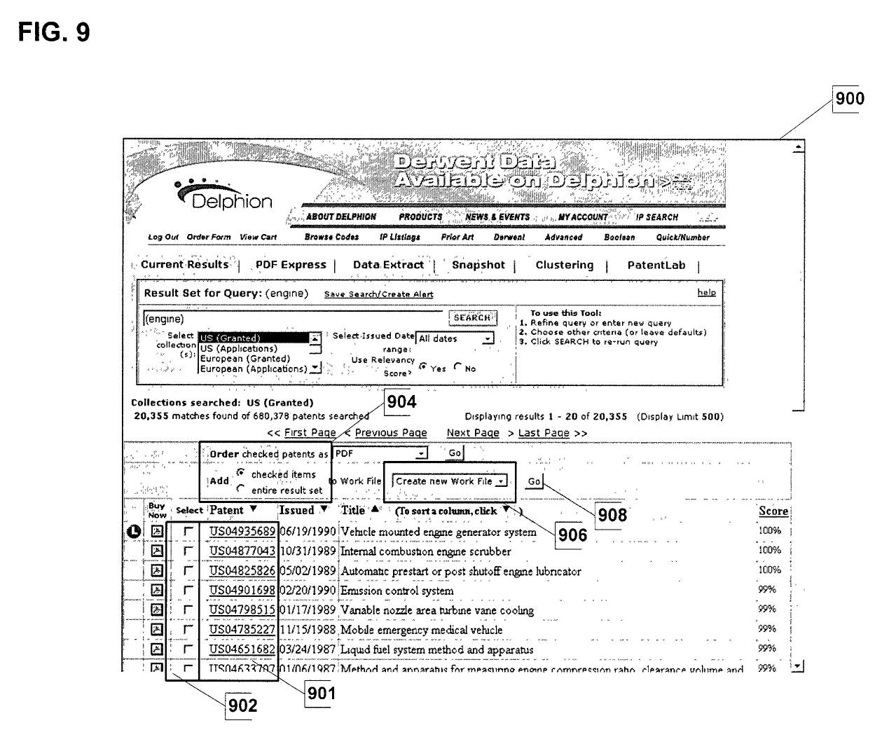

In the embodiment explained below, the user retrieves the results using a search engine format. However, anyone skilled in the art would understand that the invention of the present invention may be practiced using other information gathering resources. Referring again to FIG. 2, in this embodiment a user initiates a session through the client computer 40. The client computer 40 uses a web browser client 202 to communicate with the computer complex 50 via web server 120. Referring to FIG. 5, the steps for generating a work set using the computer complex 501 are illustrated. In step 500, the user provides a set of patents to potentially be included in a work set, such as by generating a list of patents or importing a file of patents. In one method for generating a list of patents, the user generates a list of patents by performing a keyword search for a specific word or phrase, as indicated in block 502; and the system returns a result set as indicated in block 504. An example of this is depicted in FIG. 8. In this example, the user enters a textual search query “engine” in entry field 800 and selects one or more patent collections to search by checking the checkboxes 802. The user then presses the search button 804. Referring to FIG. 2, the web browser client 202 transmits the search query (HTTP request) through the Internet 60 to web server 120. The web server 120 invokes the search client 208 that transmits the query to the search engine 218 over the data layer network 70. The search engine 218 searches the patent collections 220 by matching the given query against the words stored in the word field 404 (FIG. 4). Matching document entries are returned to the search client 208. At this point, only the first page (the number of documents shown on the first page of the search results) have been retrieved from the search engine 218. The remainder of the matching document identifiers is cached in the search engine 218 for later retrieval as explained below. The web server 120 generates a results page, an example of which is depicted in FIG. 9. A patent number list 901 is displayed along with checkboxes 902, which provide a method to select individual patents.

Referring again to FIG. 5, the user then selects which documents to include in the work set, as block 510 indicates. The user may select the entire set of documents or may select specific documents. Referring to FIG. 9 in this example, the user uses radio button 904 to select whether the work set will include the entire document set or just specific checked items. If only specific checked items are to be incorporated in the work set, the user does this by clicking the checkboxes 902 for the documents to be included in the work set. With the documents identified, the user then creates the work file, as block 520 indicates. In the example presented in FIG. 9 to initiate the work file creation process, the user selects “Create new Work File” from the drop down control 906 and presses the presses the Go button 908.

Because the document identifiers returned from the search engine 218 match the original source document ids 304 contained in patent record 302, the data does not need to be normalized. However, when a patent search engine is not used, the source data must be normalized during step 530. This typically is necessary when the data is entered directly by the user, or when an existing source of data (such as a file of document identifiers) is imported for use with the invention. The normalization process takes the source format supplied by the user or an external system and converts the data into a format consistent with the way in which the document ids 304 are stored.

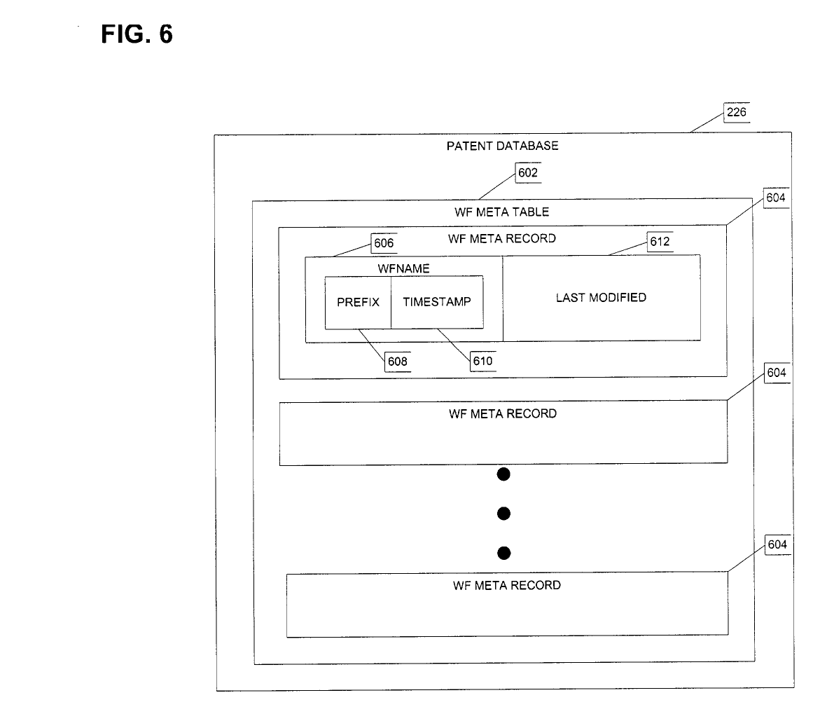

In step 540 a list of patent numbers is injected into the patent database 226 by performing the following sequence of events. The search client 208 re-executes the search query by invoking the search engine 218 and retrieves the full list of doc ids 304 from index entries 402 in patent collection 220 (FIG. 4). As previously mentioned, the search engine 218 may have already cached the full list of document ids 304. In step 542, the search client 208 creates a work file meta record (WF META RECORD) 604 in a work file meta table (WF META TABLE) 602 in patent database 226, as depicted in FIG. 6. The work file meta record 604 consists of a work file name (WFNAME) 606 and LAST MODIFIED time stamp field 612. The work file name 606 is constructed by combining a prefix 608 (database alias) and a timestamp 610. The work file name 606 is created in order to provide a system wide unique identifier. The LAST MODIFIED field 612 is set to the current system time so that (in a later step) it can be used to determine freshness of the list. Only one work file meta record 604 is created for each work file.

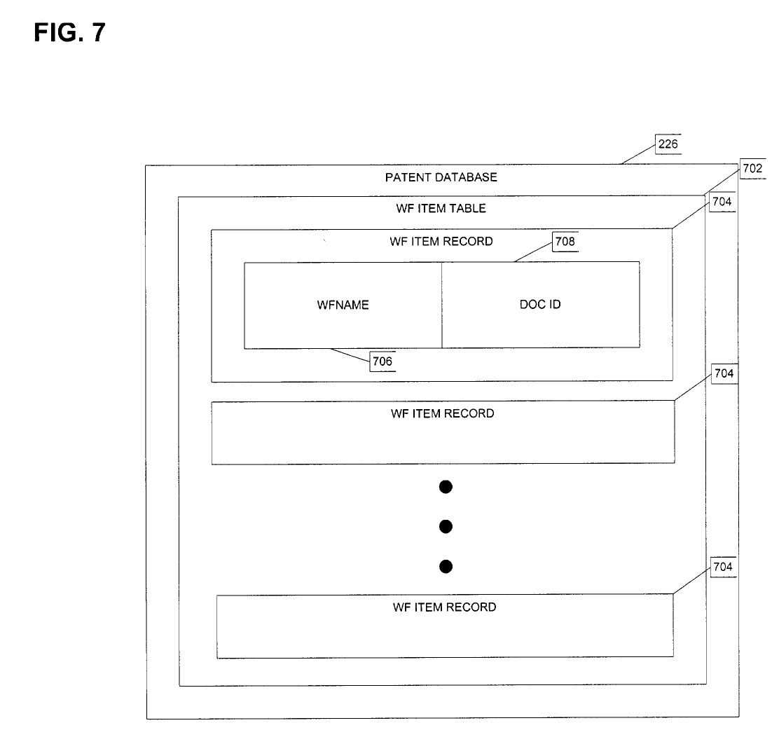

In step 544, the search client 208 creates one or more work file item records (WF ITEM RECORDS) 704 in a work file item table (WF ITEM TABLE) 702 in patent database 226, as depicted in FIG. 7. The work file item record 704 consists of a work file name (WFNAME) 706 and a document id (DOC ID) 708. The work file name 706 corresponds to the work file name 606 entry in the work file meta record 604 in work file meta table 602. The document id 708 corresponds to each document identifier returned from the user's search (or other source of data). The work file item records 704 are stored so that they can be later retrieved by the work file application 212. The document ids 708 are used for later viewing of the work file. When the work set is viewed, the document ids 708 are joined with the patent database tables 300 (FIG. 3) to display related fields of patent data. The document ids 708 or other columns of patent data may also be sorted in a variety of ways when the work set is rendered. As described later, the work file meta record 604 and work file item records 704 may be constructed and used by the system as a system work file (used for repeated operations against the same set of data). Step 550 is optionally performed to present the user with a list of patents that could not be added (injected) into the work file. At this point, a system (temporary) work file has been created that can be used repeatedly by the system to gain efficiency of operation on large work sets. As the user switches between functions (searching, requesting document copies, extracting patent data from the system, performing analysis on the documents, etc.), the system uses the work file meta table (WF META TABLE) 602, work file item table (WF ITEM TABLE) 702, and patent table 300 to quickly retrieve the appropriate document identifiers and associated patent data. The work file name (WF NAME) 606 is passed between the system components and is used to locate the document identifiers 708 that comprise the set. Those document identifiers are joined with the patent data records as needed to perform the requested functions.

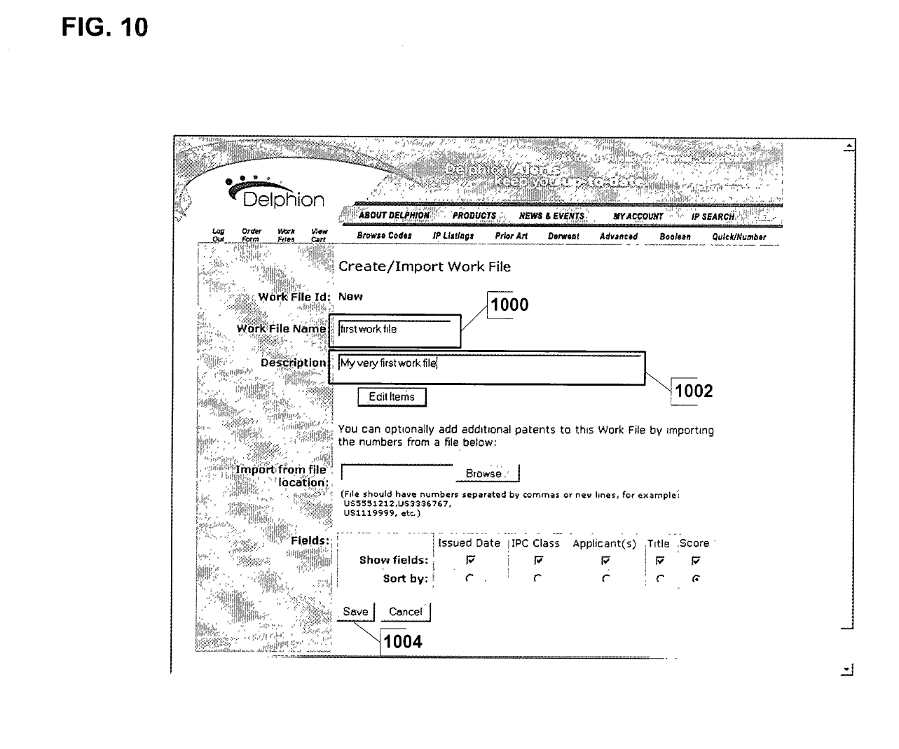

If the user has chosen to create a permanent work file so that the user can reference the work file and/or manipulate its contents, the process continues at step 560. In Step 560, the work file application 212 presents the user with a form used to supply descriptive information, as depicted in FIG. 10. The user may enter a work file name 1000 and a description 1002. Optionally, the user may import a list of patent numbers at this time (in addition to documents identifiers already supplied) and/or specify sort order used at render time. The user saves this information by pressing the save button 1004.

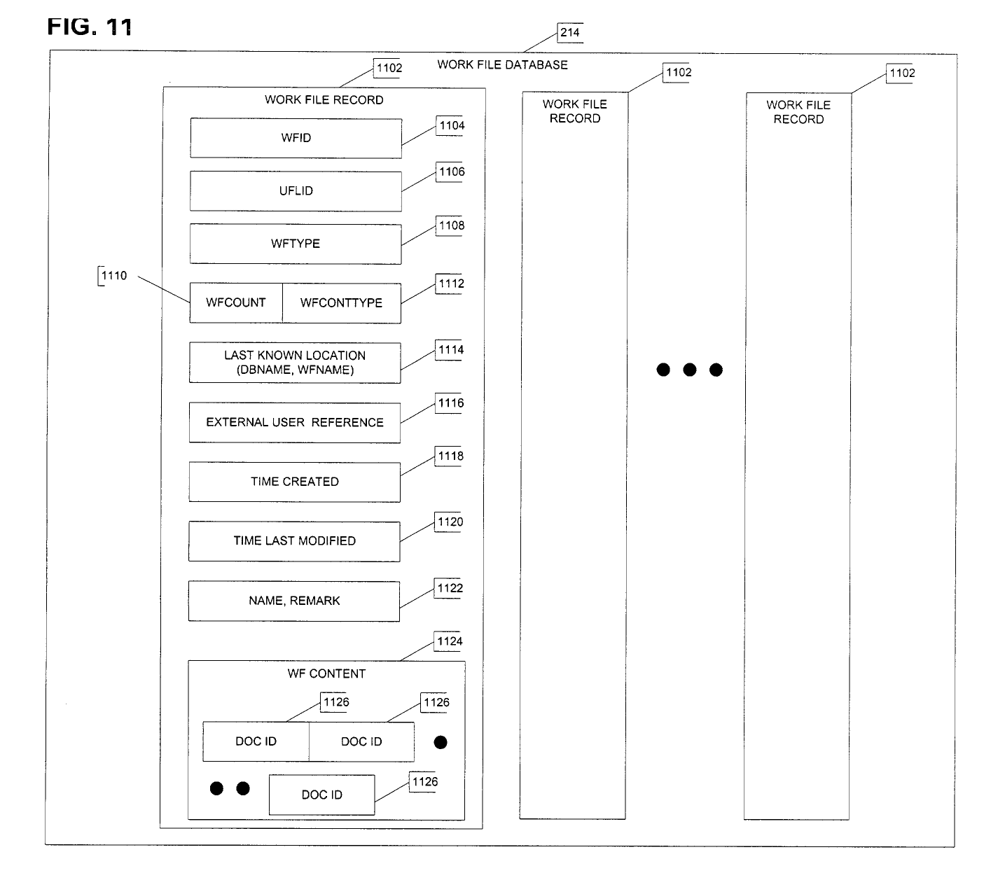

In the next step indicated at block 570, the work file application 212 generates a work file record 1102, as depicted in FIG. 11, which is a combination of the information provided by the user with the information in the work file meta record 604 and information generated by the work file application 212. The work file records 1102 are maintained on the work file database 214. In generating a work file record 1102, the work file application 212 first generates a unique value for a work file ID (WFID) field 1104. The WFID field 1104 is a unique identifier used for subsequent operations by the work file application 212. The WFID field 1104 is unique across all work files, while a UFLID field 1106 stores a unique identifier that is also created at this time. The UFLID identifier is an identifier that the user references when manipulating work files within a session. The UFLID 1106 is typically a sequentially generated number. If the user subsequently deletes work files, older UFLID numbers will not be reused. A work file type (WFTYPE) field 1108 contains data as to whether the work file is a normal, system, or hidden work file. A system work file is a temporary work file used for repeated operations using the same set of data. A hidden work file may be either a normal or system work file that is not exposed to the user. The value for the WFTYPE field 1108 is passed to the work file application 212 by the calling program. The next field stored by the work file application 212 is a work file count (WFCOUNT) field 1110, which indicates the number of patent records associated with this work file. The value for the WFCOUNT field 1110 is initially calculated by the work file application 212 by counting the number of work file item records 704 in work file item table 702. The WFCOUNT field 1110 is updated whenever items are added, deleted, or merged in the current work file. The data for the work count type (WFCOUNTTYPE) field 1112 is also stored at this time. It indicates the type of data stored in the work file. The calling program may supply the value of the WFCOUNTTYPE field 1112, or the work file application 212 may derive the value from the system environment.

While the work file record 1102 entries are being stored, a last known location (LAST KNOWN LOCATION) field 1114 is also populated. The data in the LAST KNOWN LOCATION field 1114 is a combination of the database name for patent database 226 (the location of the work file meta table 602 and the work file item table 702), as well as the value of the work file name 706 copied from the newly created work file item records 704. The data from the LAST KNOWN LOCATION field 1114 is later used to find, restore, or repair the associated work file meta record 604 and/or work file item records 704. For example, after the work file has been created and the work file application 212 determines that the work file meta and work file item records 604, 704 no longer exist in the proper location, a new location is chosen, and the work file meta and work file item records 604, 704 are re-created using the additional information stored in the work file record 1102.

In the preferred embodiment of the invention, the work file is associated with some external user of the system. The work file record 1102 stores a reference to that user in the EXTERNAL USER REFERENCE field 1116. Typically, it is a reference to an external user directory (for example, it may be a reference to an entry in a lightweight directory access protocol system, or it may be a reference to a shopper identification used by an e-commerce engine). Data for the TIME CREATED 1118 and TIME LAST MODIFIED 1120 fields are also stored at this time. As their names imply, these two fields are used to keep track of when the work file was created and when the work file was last modified (records added or deleted, for example). Both fields TIME CREATED 1118 and TIME LAST MODIFIED 1120 are initially set to the current system time.

The NAME, REMARK 1122 fields are also updated during the creation of the work file by the work file application 212. These fields are supplied by the user (or passed in by the calling program) and are critical for subsequent use of the work file by the user. The NAME, REMARK 1112 fields allow the user to associate the content of the work file with a symbolic name. For example, the work file named “Antibiotics” and remark “Antibiotic patents for my thesis” contains patents associated with the user's current research paper. In addition to associating the name and remark fields with a specific work file, the NAME, REMARK 1112 fields may be used by other components of the system to allow subsequent operations against the work file. For example a user interface may be provided that lists the work file names and/or descriptions and allows the user to conveniently add additional documents to an existing or new work file. The NAME, REMARK 1112 fields may also be passed to the work file application 212 by the calling program. For example, the value for these fields may be set by another component of the current system.

The last field created by the work file application 212 during the creation of a work file is WF CONTENT 1124. The WF CONTENT field 1124 is critical to the work file record 1102 because it contains a copy of each document id 708 field contained in every work file item table record 704 that applies to the current work file. To populate the WF CONTENT field 1124, I the work file application 212 determines if a work file meta record 604 exists where the work file name 606 is equal to the WFNAME value stored in LAST KNOWN LOCATION field 1114. If so, and if one or more work file item records 704 are found in the work file item table 702 that contain the same WFNAME value, the document id values 708 from those matching records are copied into the document id 1126 values in WF CONTENT field 1124. The DOC ID 1126 fields are depicted as a simple array of values, but anyone skilled in the art will recognize that the DOC ID 1126 fields can be stored in any efficient storage structure. The document ids 1126 are the master (and permanent) copy of the documents contained in the work set. These document ids are updated whenever the user performs an operation that changes the contents of the work set. For example, if the user adds, deletes, edits, or performs set operations, the document ids 1126 are updated to reflect the current state of the work set. (Of course, the WFCOUNT 1110 is also kept in sync with any changes to WF CONTENT 1124.) The document ids 1126 are also used as a source of data should the work file need to be cloned (as a result of a user or system request).

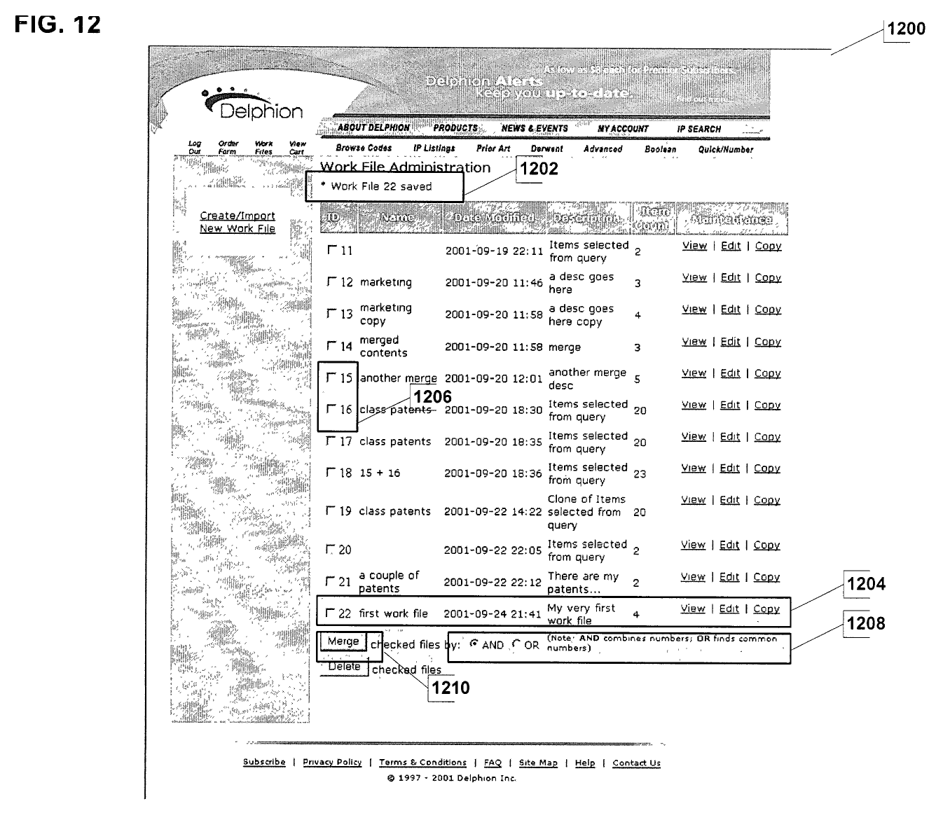

Referring again to FIG. 5, after the work file record 1102 has been created, the work file application 212 displays a confirmation message to the user, as block 580 indicates. Referring to FIG. 12, the work file application 212 does this by displaying a Work File Administration user interface page 1200. The confirmation message 1202 indicates that the work file has been saved successfully. In addition, the administration page 1200 contains a newly created row 1204 that displays the user's work file ID number, the work file name, last modified date, description, the count of items currently contained in the work file, and a set of links to other administrative functions such as view, edit, or copy. At this point, the work file generation and confirmation process is complete.

In a variation of the work file administration interface, it's also possible to construct custom patent collections. For example, all patents invented by Thomas Edison. A user interface is provided to allow a user to collect a set of patents, arrange aspects of the list (e.g., decide whether to show thumbnail images, titles, etc.), provide a custom header to be shown when the work file is viewed (e.g. an image of one of the inventions or a company logo), and subsequently publish the work set on the Internet (provide a URL link to the resulting page).

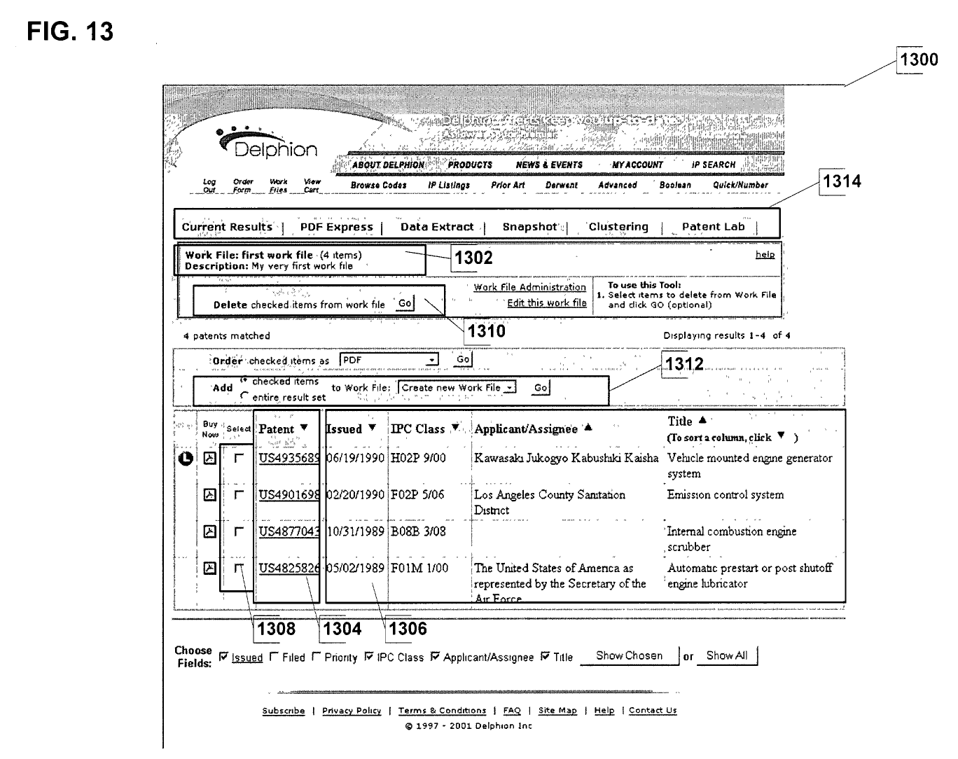

From the work file administration user interface 1200, the user may view the patent documents that comprise each of the listed work files. FIG. 13 depicts an embodiment of a work file viewer user interface 1300. The work file viewer allows the user to view the contents of a work file along with additional fields of patent information pulled from the patent database. The work file viewer 1300 is generated by the work file application 212 when the view control 1204 is selected. The view control 1204 invokes the work file application 212 and passes it the value of the work file ID 1104. The work file application 212 then uses the work file record (WORK FILE RECORD) 1102 along with the associated work file meta record (WF META RECORD) 604 and work file item records (WF ITEM RECORD) 704 to display the contents of the work file. The work file viewer 1300 shows the name, description and number of items 1302 by retrieving values from the work file record 1102. To display the document identifiers 1304 and associated patent data 1306, the work file application 212 uses the value of the last known location (LAST KNOWN LOCATION) 1114 field in the work file record (WORK FILE RECORD) 1102 to find the associated work file meta record (WF META RECORD) 604 for this work file. The work file name (WF NAME) 606 is then retrieved and used to find all work file item records (WF ITEM RECORD) 704 that contain a matching work file name (WFNAME) 706. This set of work file item records (WF ITEM RECORD) 704 is then used to retrieve the list of document identifiers (DOC ID) 708. This set of document identifiers (DOC ID) 708 is then used to find associated patent records 302. This set of patent records 302 is sorted according to the user's preference and displayed on the work file viewer user interface 1300 as depicted in 1304, 1306. In one embodiment, if the number of items to display on the work file viewer user interface 1300 is greater than a predetermined limit, then only the first X items are shown. In this case, additional scrolling controls would be shown that allow the user to request the next X items or jump to the beginning or end of the work file.

The user may also delete items by using the work file viewer user interface 1300. First, the user selects the desired items to delete by clicking on the checkboxes 1308. The user will then press the Go button 1310. The work file application responds by deleting the matching work file item records (WF ITEM RECORD) 704, deleting the corresponding work file meta record (WF META RECORD) 604, updating the TIME LAST MODIFIED 1120 field with the current system time, deleting matching document identifiers (DOC ID) 1126 from WF CONTENT 1124, and finally setting WFCOUNT 1110 to the number of document identifiers (DOC ID) 1126 remaining in WF CONTENT 1124. The work file application 212 then removes the deleted items from the work file viewer user interface 1300 and redisplays the page (the items are no longer visible to the user). In addition to deleting items, the user may also copy some or all of the existing set of documents (current work file) into a new or existing work file. To copy documents into a new, work file, the user optionally selects document identifiers 1304, sets the Add radio button to either “checked items” or “entire result set,” 1312, leaves the drop-down control set to “Create New Work File” 1312, and presses the “Go” button 1312. Depending on the user's selection, the work file application 212 is passed either a list of document identifiers 1304 or the work file ID (WFID) 1104 of the currently viewed work file. The work file application 212 then creates a new work file as previously described in step 520 above, using the current work file document identifiers as the source for the operation. To copy documents into an existing work file, the user optionally selects document identifiers 1304, sets the Add radio button to either “checked items” or “entire result set,” 1312, presses the drop-down control 1312, selects an existing work file name from the drop-down, and presses the “Go” button 1312. At this point, the work file application 212 inserts the document identifiers from the current work file into the work file structures associated with the existing work file chosen from the drop-down. Any duplicate document identifiers are removed, and the appropriate structures in the work file meta table (WF META TABLE) 602, work file item table (WF ITEM TABLE) 702, and work file record 1102 are updated to reflect the combined content. When using the work file viewer 1300, the user may also perform all of the same system features 1314 as were also possible from the search result set user interface 900 (FIG. 9).

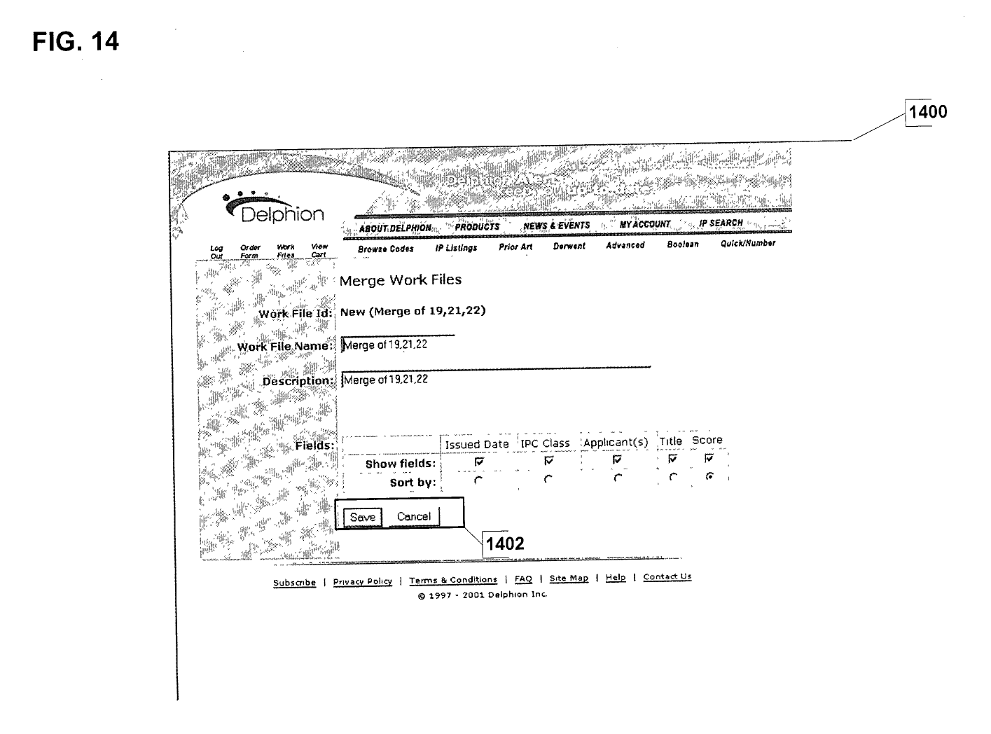

In addition to performing operations on individual work files using the work file administration user interface 1200 such as view, edit, copy, or import, the user may also perform operations between multiple work files. For example, a merge operation may be utilized to create subsets or supersets of existing work files by merging multiple work files to create a new work file. To perform a merge, the user may select several work files (for example, using checkboxes 1206 (FIG. 12)), choose a logical AND or OR operation via radio buttons 1208, and press the merge button 1210. A merge user interface screen 1400 is depicted as shown in FIG. 14. When the save button 1402 is pressed, a newly merged work file is created. The merge implementation may support at least two different operations: logical AND and logical OR. When several work files are selected and a logical OR operation is performed a new destination work file is produced. The WF CONTENT 1126 of the destination file is the union of the document ids 1126 contained in all selected work files. The result of the union is then sorted alphabetically, duplicate document ids are removed, and the resulting list is then stored in WF CONTENT 1126 of the new work file. When several work files are selected and a logical AND operation is performed, a new destination work file is produced. The WF CONTENT 1126 of the destination work file after the AND merge operation is the intersection of the documents ids 1126 contained in all selected work files. In this case, the resulting document ids are joined and sorted. If the number of source work sets is N, then all documents ids are removed from the generated set except document ids with N times occurrence. The final step in the AND merge operation is to remove duplicate document ids from the resulting list and to store the remainder in WF CONTENT 1126 of a new work file. The Quick Sort algorithm (or similar) is used in sort operations for the purpose of higher efficiency.

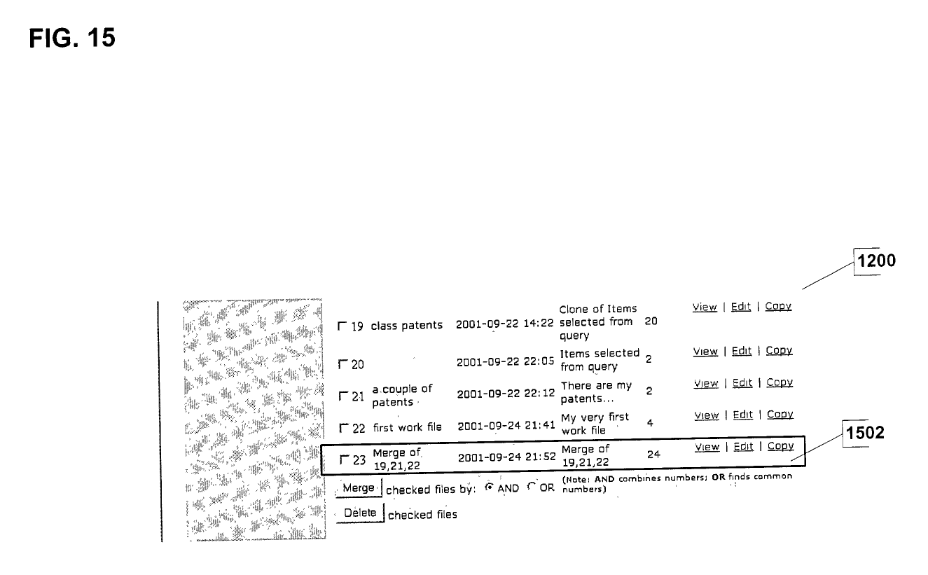

The user interface for the newly merged work file 1502 is depicted in FIG. 15 as displayed in the work file administration user interface 1200. A variation of work file administration user interface 1200 allows other set operations, such as the capability to perform complex Boolean operations. For example, ((set 1 OR set 2) AND set 3) AND NOT set 4).

As discussed above, embodiments of the system of the invention allow the user to consciously create the work file. However, the system may also automatically create work sets during the user interaction without the user's direct knowledge. These system work sets may be hidden from the user, or they may be exposed to the user on the work file administration user interface 1200 or other user interface pages. Typically the NAME, REMARK 1122 fields are initially left blank in this case, but may be subsequently supplied by the user.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

What is claimed is:

1. A method for generating a work set of documents, comprising:
providing a database of documents wherein each document is represented by a document record having an assigned document identifier;
generating a list of documents to be grouped together; and
generating at least one work file record having a work file name and containing the document identifier for at least one of the documents listed on the list of documents to be grouped together.

2. The method for generating a work set of documents of claim 1 wherein the documents in the database are patent documents.

3. The method for generating a work set of documents of claim 1 wherein the list of documents to be grouped together is generated through a computer search.

4. The method for generating a work set of documents of claim 1 further comprising adding a document identifier to the work file record.

5. The method for generating a work set of documents of claim 1 further comprising deleting a document identifier from the work file record.

6. The method for generating a work set of documents of claim 1 further comprising:
generating a second list of documents to be grouped together; and
generating a second work file record having a work file name and containing the document identifier for at least one of the documents listed on the second list of documents to be grouped together.

7. The method for generating a work set of documents of claim 6 further comprising merging the first and second work file records to create a merged work file.

8. The method for generating a work set of documents of claim 1 further comprising performing analysis on the documents identified by the work file record.

9. The method for generating a work set of documents of claim 1 wherein the generated work file record is a temporary record.

10. The method for generating a work set of documents of claim 1 wherein the generated work file record is a permanent record.

11. The method for generating a work set of documents of claim 1 wherein the documents identified by the work file record are updated on a set time frame.

12. A system for generating a work set of documents, comprising:
a database of documents wherein each document is represented by a document record having an assigned document identifier; and
a server having a work file generation program; wherein when the work file generation program is provided with a list of documents to be grouped together and is executed, the work file generation program generates at least one work file record having a work file name and containing the document identifier for at least one of the documents listed on the list of documents to be grouped together.

13. The system for generating a work set of documents of claim 12 wherein the documents in the database are patent documents.

14. The system for generating a work set of documents of claim 12 wherein the list of documents to be grouped together is generated through a computer search.

15. The system for generating a work set of documents of claim 12 wherein the list of documents to be grouped together is a file imported into the work file generation program.

16. The system for generating a work set of documents of claim 15 wherein the document identifiers imported into the work file generation program are normalized to the document identifiers used by the document database.

17. The system for generating a work set of documents of claim 12 wherein the work file generation program adds a document identifier to the work file record.

18. The system for generating a work set of documents of claim 12 wherein the work file generation program deletes a document identifier from the work file record.

19. The system for generating a work set of documents of claim 12 further comprising:
the work file generation program generating a second work file record from a second list of documents to be grouped together, wherein the second work file record has a work file name and contains the document identifier for at least one of the documents listed on the second list of documents to be grouped together.

20. The system for generating a work set of documents of claim 19 wherein the work file generation program merges the first and second work file records to create a merged work file.

21. The system for generating a work set of documents of claim 12 wherein the system performs analysis on the documents identified by the work file record.

22. The system for generating a work set of documents of claim 12 wherein the generated work file record is a temporary record.

23. The system for generating a work set of documents of claim 12 wherein the generated work file record is a permanent record.

24. The system for generating a work set of documents of claim 12 wherein the documents identified by the work file record are updated by the work file generation program on a set time frame.

25. A computer readable medium having computer executable instructions for performing the method of generating a work set of documents comprising:
capturing a list of documents to be grouped together from a provided list; and
generating at least one work file record from the captured list of documents; wherein the generated work file record has a work file name and contains a document identifier which corresponds to a document record on a document database for at least one of the documents listed on the list of documents to be grouped together.

26. The computer-implemented method for generating a work set of documents of claim 25 wherein the documents in the database are patent documents.

27. The computer-implemented method for generating a work set of documents of claim 25 wherein the list of documents to be grouped together is generated through a computer search.

28. The computer-implemented method for generating a work set of documents of claim 25 wherein the list of documents to be grouped together is captured from an imported file.

29. The computer-implemented method for generating a work set of documents of claim 28 wherein the document identifiers captured from the imported file are normalized to the document identifiers used by the document database.

30. The computer-implemented method for generating a work set of documents of claim 25 further comprising adding a document identifier to the work file record.

31. The computer-implemented method for generating a work set of documents of claim 25 further comprising deleting a document identifier from the work file record.

32. The computer-implemented method for generating a work set of documents of claim 25 further comprising:
capturing a second list of documents to be grouped together from a provided list, and
generating a second work file record having a work file name and containing the document identifier for at least one of the documents listed on the second list of documents to be grouped together.

33. The computer-implemented method for generating a work set of documents of claim 32 further comprising merging the first and second work file records to create a merged work file.

34. The computer-implemented method for generating a work set of documents of claim 25 further comprising performing analysis on the documents identified by the work file record.

35. The computer-implemented method for generating a work set of documents of claim 25 wherein the generated work file record is a temporary record.

36. The computer-implemented method for generating a work set of documents of claim 25 wherein the generated work file record is a permanent record.

37. The computer-implemented method for generating a work set of documents of claim 25 wherein the documents identified by the work file record are updated on a set time frame.
